(19) United States
(12) Patent Application Publication
(10) Pub. No.: US 2014/0274708 A1
(43) Pub. Date: Sep. 18, 2014

(54) METHOD FOR CONTROL OF BRUSH AND WOODY WEED SPECIES

(71) Applicant: Dow AgroSciences LLC, Indianapolis, IN (US)

(72) Inventors: Neivaldo Tunes Caceres, Sao Jose Do Rio Preto (BR); Reginaldo Farias Souza, Araguaina (BR)

(73) Assignee: Dow AgroSciences LLC, Indianapolis, IN (US)

(21) Appl. No.: 14/201,416

(22) Filed: Mar. 7, 2014

Related U.S. Application Data
(60) Provisional application No. 61/775,050, filed on Mar. 8, 2013.

(51) Int. Cl. A01N 43/40

(52) U.S. Cl. CPC A01N 43/40
USPC 504/130

(57) ABSTRACT

Basal application of an herbicidal composition comprising triclopyr butoxyethyl ester, picloram-isooctyl ester, and glycerine controls undesirable woody vegetation.

### CROSS REFERENCE TO RELATED APPLICATIONS

This application claims the benefit of U.S. Provisional Patent Application Ser. No. 61/775,050 filed Mar. 8, 2013, the disclosure of which is expressly incorporated herein by reference.

### BACKGROUND

Today's increased attention to nature and the environment has resulted in unprecedented efforts to encourage grasses, low-growing ground cover, and wildflowers on rights-of-way. Thus, individual plant control treatments are desirable to remove tall-growing woody plants through low-profile vegetation control programs. Not only do such treatment programs result in effective, long lasting brush control, they leave non-target plants virtually untouched. This allows annual and perennial grasses and other desired plants to thrive because they are freed from competition for moisture, nutrients and sunlight, thereby promoting the development of desired ground cover resulting in aesthetically pleasing rights-of-way.

One such treatment program consists of the use of basal bark or stem application of a herbicide to control undesired vegetation. Basal bark or stem applications of herbicidal compositions requires the herbicide to pass through the bark into the appoplast or symplast of the plant where movement to the site of activity can take place. It is well known that when applying the herbicide by basal or stem application, it is desirable to dissolve the herbicide in a non-aqueous organic carrier. Water-based diluents are not efficacious due to the lack of affinity between such diluents and the wax and non-polar compounds present in the bark. Organic carriers currently used consist of petroleum distillates, such as fuel oils, for example, diesel oil or kerosene. These petroleum distillate carriers provide for penetration of the herbicide through the bark of the vegetation to be controlled. However, these carriers present risks not only to the surrounding environment, but also to the applicator as well. When making basal or stem applications, application technique and packaging may not eliminate all contact of the herbicidal composition with skin or clothing. Also, due to applicator technique or wind conditions, over-spray onto surrounding areas may result during the application. Herbicide carriers such as diesel fuel and kerosene, are low grade petroleum products containing impurities, such as benzene, benzo[a]pyrene, and polycyclic aromatic hydrocarbons, and may pose a potential risk to human health. Thus, in order to pose less environmental and applicator exposures to petroleum distillates, new alternative herbicidal carriers are desirable in efforts to control undesired vegetation. In addition, new carriers which may increase uptake, translocation, or efficacy of the active herbicide are also desirable.

TOGAR TB™ is a Dow AgroSciences LLC herbicide product marketed in South America for control of broadleaved weeds, semi-shrubs and shrubs in pastures. It has customarily been recommended that from 4.0 to 8.0 liters (L) of TOGAR TB be mixed with 96.0 or 92.0 liters of diesel fuel (4% to 8% volume per volume (v/v)) for basal application. The mixture is applied by spraying by hand on all sides of the bottom third of weeds.

### SUMMARY

Provided herein are methods for controlling undesirable woody vegetation which comprises basal application of an herbicidal composition comprising triclopyr butoxyethyl ester, picloram-isooctyl ester, and glycerin as herbicide carrier.

### DETAILED DESCRIPTION

### Definitions

Triclopyr is the common name for 3,5,6-trichloro-2-pyridyloxyacetic acid. As described in Tomlin, C. D. S., Ed. The Pesticide Manual: A World Compendium, 15^{th} ed.; BCPC: Alton, 2009 (hereafter “The Pesticide Manual”), this compound is a selective systemic herbicide used in the control of brush and woody vegetation, and many broad-leaved weeds, in areas such as grasslands and other uncultivated lands, industrial areas, rights-of-way, coniferous forests, oil palm, rubber plantations and rice.

Picloram is the common name for 4-amino-3,5,6-trichloropicolinic acid. As described in The Pesticide Manual, it is also a selective systemic herbicide, and salts and esters of picloram are used to control brush and woody vegetation and many broad-leaved weeds, in areas such as grasslands and other uncultivated lands, industrial areas, and rights-of-way.

Glycerin (glycerol) is the compound (CH₂OH)₂CHOH. It is a colorless, odorless, viscous liquid that is widely used in pharmaceutical formulations. It is obtained by the saponification of fats in the soap industry and is produced in large amounts as a by-product of bio-diesel production.

TOGAR TB™ herbicide is composed of:
triclopyr-butoxyethyl ester (butoxyethyl 3,5,6-trichloro-2-pyridyloxyacetate) 83.53 grams per liter (g/L), 9.22% weight per weight (w/w) (60.10 grams acid equivalent per liter (g ae/L), 6.62% w/w);
picloram-isooctyl ester (isooctyl 4-amino-3,5,6-trichloropicolinate) 43.94 g/L, 4.85% w/w (30.00 g ae/L, 3.31% w/w);
inert ingredients 778.52 g/L, 85.93% w/w.

As used herein, control of or controlling undesirable vegetation means killing or preventing the vegetation, or causing some other adverse modifying effect to the vegetation e.g., deviations from natural growth or development, regulation, desiccation, retardation, and the like.

As used herein, herbicide and herbicidal active ingredient mean a compound that controls undesirable vegetation when applied in an appropriate amount.

As used herein, a herbicidally effective or vegetation controlling amount is an amount of herbicidal active ingredient the application of which controls the relevant undesirable vegetation.

As used herein, basal application means hand delivering a herbicide directly to the bark on the lower 12 to 18 inches of the trunk or stem of an undesirable plant. Hand spraying or other equivalent delivery method can be used.

### Compositions and Methods

Provided herein are methods for controlling undesirable woody vegetation which comprises basal application of a herbicidally effective amount of an herbicidal composition comprising triclopyr-butoxyethyl ester, picloram-isooctyl ester, and glycerine.

In certain embodiments the herbicidal composition used in the method contains up to 0.5 L of water per liter of glycerine.

In certain embodiments the herbicidal composition used in the method contains 3.4 to 8.6 g /L (2.45 to 6.19 g ae/L) of triclopyr-butoxyethyl ester and 1.75 to 4.4 g/L (1.2 to 3 g ae/L) of picloram-isooctyl ester.

The spray mixtures provided herein can be prepared by diluting TOGAR TB™ in glycerine and, optionally, water at a ratio of from 4-10 L of TOGAR TB™ per 96-62 L of glycerine and 0-30 L of water.

In addition to the compositions and uses set forth above, the present disclosure also embraces the composition and use of these compositions in combination with one or more additional compatible ingredients. Other additional ingredients may include, for example, one or more other herbicides, dyes, and any other additional ingredients providing functional utility, such as, for example, stabilizers, fragrants, viscosity-lowering additaments, and freeze-point depressants.

Additional herbicidal compounds employed as supplements or additaments should not be antagonistic to the activity of the triclopyr-butoxyethyl ester/picloram-isooctyl ester composition. Suitable herbicidal compounds include, but are not limited to 2,4-D, ametryn, aminopyralid, asulam, atrazine, butafenacil, carfentrazone-ethyl, chlorflurenol, chlormequat, chlorpropham, chlorsulfuron, chlortoluron, cinosulfuron, clethodim, clopyralid, cyclosulfamuron, dicamba, dichlobenil, dichlorprop-P, diclosulam, diflufenican, diflufenzopyr, diuron, fluroxypyr, glyphosate, hexazinone, imazamox, imazapic, imazapyr, imazaquin, imazethapyr, imazosulfuron, MCPA, metsulfuron-methyl, pyrithiobac-sodium, pyroxsulam, sethoxydim, sulfometuron, sulfosate, sulfosulfuron, tebuthiuron, terbacil, thiazopyr, thifensulfuron, triasulfuron and tribenuron. Particularly useful herbicidal compounds for use with triclopyr-butoxyethyl ester in foliar brush-control applications are clopyralid esters and amines, e.g., 3,6-dichloropicolinic acid monoethanolamine salt, as well as mixtures with 2,4-D-butoxyethyl ester, with fluroxypyr-1-methylheptyl ester, with picloram-isooctyl ester and with aminopyralid salts. The herbicidal composition used in the methods provided herein can be formulated with the other herbicide or herbicides, tank-mixed with the other herbicide or herbicides, or applied sequentially with the other herbicide or herbicides.

Dyes may be used in the formulated composition as a marker. In some embodiments, the dye can be any oil-soluble dye selected from EPA's approved list of inerts exempt from tolerance. Such dyes may include, for example, D&C Red #17, D&C Violet #2, and D&C Green #6. Dyes are generally added to the composition by adding the desired amount of dye to the formulated composition with agitation. Dyes are generally present in the final formulation composition in a concentration of 0.1-1.0 percent by weight.

### EXAMPLES

Example 1

### Herbicidal Testing

Trial information:

| Crop | Pasture grasses |
|---|---|
| Experimental | Randomized Complete Block, 4 replications |
| Design | |
| Plot Size | 20 plants |
| Spray Volume | 60 to 100 milliliters (mL)/plant |
| Equipment | Backpack hand pumped sprayer with a single variable |
| | angle cone nozzle |
| Target weed | Memora peregrina (MEMPR), and 3 species without |
| | bayer code defined: quina, mucunã and murta |
| Assessment | Monthly and up to final control after 150 DAA |
| Variables | Percent (%) defoliation and % control |
| Location | São Francisco do Brejão-MA/Ananás and Peixe-TO |
| Applications | 1 |

Treatments:

| Trt | Treatment | Diluent |
|---|---|---|
| 1 | TOGAR BT - 8% | DIESEL FUEL - 92% |
| 2 | TOGAR BT - 8% | GLYCERINE - 92% |
| 5 | TOGAR BT - 8% | GLYCERINE - 62% |
| | | WATER - 30% |
| 6 | UNTREATED | |

Togar TB™ at 8% diluted in glycerin presented the same performance in quina, mucunã, murta and Memora peregrina final control, when compared to Togar TB™, in the same concentration, diluted in diesel, the current standard diluent, when applied basal in the weeds (Table 1). This disclosure represents a significant benefit to users, with a relative 50% reduction in cost of treatment due to the difference of costs between diesel and glycerin.

TABLE 1
Percent (%) Control Visually Rated

| Trt | Treatment | Diluent | Quina | Mucunã | Murta | MEMPR |
|---|---|---|---|---|---|---|
| 1 | TOGAR | Diesel | 100 a | 100 a | 100 a | 100 a |
| | BT - 8% | Fuel - | | | | |
| | | 92% | | | | |
| 2 | TOGAR | Glycer- | 99 a | 100 a | 96 a | 95 b |
| | BT - 8% | ine - 92% | | | | |
| 5 | TOGAR | Glycer- | 84 b | 94 b | 90 b | 83 c |
| | BT - 8% | ine - 62% | | | | |
| | | Water - | | | | |
| | | 30% | | | | |
| 6 | UNTREATED | | 0 c | 0 c | 0 c | 0 d |

Means followed by same letter do not significantly differ (P = .10, Tukey's HSD)

1. A method for controlling undesirable woody vegetation which comprises basally applying a herbicidally effective amount of an herbicidal composition comprising triclopyr butoxyethyl ester, picloram-isooctyl ester, and glycerine.

2. The method of claim 1 wherein the herbicidal composition comprises up to 0.5 L of water per liter of glycerine.

3. The method of claim 1 wherein the herbicidal composition comprises 3.4 to 8.6 g/L of triclopyr-butoxyethyl ester and 1.75 to 4.4 g/L of picloram-isooctyl ester.

4. The method of claim 1 wherein the herbicidal composition comprises about 6.4 g/L of triclopyr-butoxyethyl ester and about 3.5 g/L of picloram-isooctyl ester.

5. The method of claim 1 wherein the herbicidal composition comprises 8% v/v of a triclopyr and picloram product, 62% to 92% v/v of glycerine, and 0 to 30% v/v of water.

6. The method of claim 1 wherein the undesirable woody vegetation is Memora.

7. The method of claim 6 wherein the undesirable woody vegetation is Memora peregrina, quina, mucunã, or murta.

8. A herbicidal composition comprising a herbicidally effective amount of triclopyr-butoxyethyl ester, picloram isooctyl ester, and glycerine.

9. The composition of claim 8, further comprising up to 0.5 L of water per liter of glycerine.
